(19) United States
(12) Patent Application Publication
(10) Pub. No.: US 2023/0345993 A1
(43) Pub. Date: Nov. 2, 2023

(54) METHOD FOR PREVENTING AGGLOMERATION IN MIXTURE OF XYLITOL AND CALCIUM ASPARTATE

(71) Applicant: ZHEJIANG HUAKANG PHARMACEUTICAL CO., LTD., Quzhou (CN)

(72) Inventors: Baoxing MAO, Quzhou (CN); Chengjun LIAO, Quzhou (CN); Xiuxiu WANG, Quzhou (CN); Ziyao WEI, Quzhou (CN); Aijuan WU, Quzhou (CN); Jiaxing LUO, Quzhou (CN); Cui LIN, Quzhou (CN); Mian LI, Quzhou (CN)

(73) Assignee: ZHEJIANG HUAKANG PHARMACEUTICAL CO., LTD., Quzhou (CN)

(21) Appl. No.: 18/347,540

(22) Filed: Jul. 5, 2023

Related U.S. Application Data
(63) Continuation of application No. PCT/CN2022/133107, filed on Nov. 21, 2022.

(30) Foreign Application Priority Data
Dec. 17, 2021 (CN) 202111553362.X

(51) Int. Cl. A23P 10/43; A23L 33/16; A23L 33/125

(52) U.S. Cl. CPC A23P 10/43; A23L 33/16; A23L 33/125

(57) ABSTRACT

The present disclosure relates a method for preventing agglomeration in a mixture of xylitol and calcium aspartate. The method includes the following steps: first adjusting and measuring water activities of xylitol particles and calcium aspartate particles; then mixing the calcium aspartate particles with a water activity in a range of 0.50-0.52 with the xylitol particles with a water activity in a range of 0.48-0.56 to obtain a mixture of xylitol and calcium aspartate; or mixing the calcium aspartate particles with a water activity in a range of 0.52-0.58 with the xylitol particles with a water activity in a range of 0.50-0.60 to obtain a mixture of xylitol and calcium aspartate; or adding maltitol particles in a weight ratio of 5%-20% to a total mass of the xylitol particles and the maltitol particles to the mixture of xylitol and calcium aspartate. By controlling the water activities of the xylitol particles and the calcium aspartate particles, or by adding maltitol in the mixture of xylitol and calcium aspartate, agglomeration of the mixture can be effectively prevented, and the method is applicable to various mixtures containing xylitol and calcium aspartate.

### CROSS-REFERENCE TO RELATED APPLICATIONS

This application is a Continuation of International Patent Application No. PCT/CN2022/133107, filed on Nov. 21, 2022, which claims priority to the Chinese Patent Application No. 202111553362.X, filed on Dec. 17, 2021, the entire contents of each of which are herein by reference.

### TECHNICAL FIELD

The present disclosure relates to the field of application of sugar alcohol, and in particular to, a method for preventing the agglomeration in a mixture of xylitol and calcium aspartate.

### BACKGROUND

Calcium aspartate is a chelated form of calcium with a biologically active structure. It is characterized by a stable chemical structure, good water solubility, and high absorption rate in the human body. The calcium aspartate, as a new generation calcium nutrient fortifier, has a wide range of applications in industries such as medicine and food. Xylitol, as a functional sugar alcohol sweetener, is widely used in the food industry.

Some products currently contain both xylitol and calcium aspartate, but there is a certain risk of agglomeration and caking after the two are mixed due to the hygroscopicity of xylitol and the hygroscopicity and viscosity of calcium aspartate. To prevent such condition, some components are often added in some food formulations. For example, patent application CN201711212727.6 discloses a chelated calcium solid beverage containing three components: calcium aspartate, maltodextrin, and xylitol. Maltodextrin helps prevent agglomeration and increase the volume of the product, but the amount of maltodextrin added is relatively large and is not suitable for products that mainly consist of xylitol and calcium aspartate. Therefore, it is desirable to provide a method for preventing agglomeration in a mixture of xylitol and calcium aspartate, thereby facilitating the mixed application of xylitol and calcium aspartate in products.

### SUMMARY

The present disclosure provides a method for preventing the agglomeration in a mixture of xylitol and calcium aspartate, thereby solving the problem of agglomeration after xylitol and calcium aspartate are mixed.

The disclosure provides a method for preventing the agglomeration in a mixture of xylitol and calcium aspartate. The method includes the following steps: first adjusting and measuring water activities of xylitol particles and calcium aspartate particles; and mixing calcium aspartate particles with a water activity in a range of 0.50 to 0.52 and xylitol particles with a water activity in a range of 0.48 to 0.56 to obtain a mixture of xylitol and calcium aspartate; or adding maltitol particles in a weight ratio of 5%-20% to a total mass of the xylitol particles and the maltitol particles to the mixture of xylitol and calcium aspartate. Particle sizes of the xylitol particles are in a range of 10 mesh to 80 mesh.

Furthermore, when maltitol particles in a weight ratio of 5% to the total mass of the xylitol particles and the maltitol particles are added to the mixture of xylitol and calcium aspartate, xylitol particles with a water activity in a range of 0.46 to 0.58 and calcium aspartate particles with a water activity in a range of 0.50 to 0.52 are mixed to obtain a mixture without agglomeration.

Furthermore, when maltitol particles in a weight ratio of 10% to the total mass of the xylitol particles and the maltitol particles are added to the mixture of xylitol and calcium aspartate, xylitol particles with a water activity in a range of 0.43 to 0.60 and calcium aspartate particles with a water activity in a range of 0.50 to 0.52 are mixed to obtain a mixture without agglomeration.

Furthermore, when maltitol particles in a weight ratio of 15% to the total mass of the xylitol particles and the maltitol particles are added to the mixture of xylitol and calcium aspartate, xylitol particles with a water activity in a range of 0.40 to 0.62 and calcium aspartate particles with a water activity in a range of 0.50 to 0.52 are mixed to obtain a mixture without agglomeration.

Furthermore, when maltitol particles in a weight ratio of 20% to the total mass of the xylitol particles and the maltitol particles are added to the mixture of xylitol and calcium aspartate, xylitol particles with a water activity in a range of 0.36 to 0.66 and calcium aspartate particles with a water activity in a range of 0.50 to 0.52 are mixed to obtain a mixture without agglomeration.

This disclosure provides a method for preventing the agglomeration in a mixture of xylitol and calcium aspartate. The method includes the following steps: first adjusting and measuring water activities of xylitol particles and calcium aspartate particles; and mixing calcium aspartate particles with a water activity in a range of 0.52 to 0.58 and xylitol particles with a water activity in a range of 0.50 to 0.60 to obtain a mixture of xylitol and calcium aspartate without agglomeration; or adding maltitol particles in a weight ratio of 5%-20% to a total mass of the xylitol particles and the maltitol particles to the mixture of xylitol and calcium aspartate. The particle sizes of the xylitol particles are in a range of 10 mesh to 80 mesh.

Furthermore, when maltitol particles in a weight ratio of 5% to the total mass of the xylitol particles and the maltitol particles are added to the mixture of xylitol and calcium aspartate, xylitol particles with a water activity in a range of 0.48 to 0.62 and calcium aspartate particles with a water activity in a range of 0.52 to 0.58 are mixed to obtain a mixture without agglomeration.

Furthermore, when maltitol particles in a weight ratio of 10% to the total mass of the xylitol particles and the maltitol particles are added to the mixture of xylitol and calcium aspartate, xylitol particles with a water activity in a range of 0.46 to 0.63 and calcium aspartate particles with a water activity in a range of 0.52 to 0.58 are mixed to obtain a mixture without agglomeration.

Furthermore, when maltitol particles in a weight ratio of 15% to the total mass of the xylitol particles and the maltitol particles are added to the mixture of xylitol and calcium aspartate, xylitol particles with a water activity in a range of 0.43 to 0.65 and calcium aspartate particles with a water activity in a range of 0.52 to 0.58 are mixed to obtain a mixture without agglomeration.

Furthermore, when maltitol particles in a weight ratio of 20% to the total mass of the xylitol particles and the maltitol particles are added to the mixture of xylitol and calcium aspartate, xylitol particles with a water activity in a range of 0.40 to 0.67 and calcium aspartate particles with a water activity in a range of 0.52 to 0.58 are mixed to obtain a mixture without agglomeration.

By controlling the water activities of the xylitol particles and the calcium aspartate particles, or adding maltitol to the mixture of xylitol and calcium aspartate, the present disclosure can effectively prevent agglomeration of the composite product, which is suitable for various mixtures containing xylitol and calcium aspartate.

### DETAILED DESCRIPTION

In order to more clearly illustrate the technical solutions of the embodiments of the present disclosure, the following embodiments are described in detail. It should be understood that the specific examples described here are only for the purpose of explaining the present disclosure, and not intended to limit the scope of the present disclosure.

### Example 1

Water activities of xylitol particles and calcium aspartate particles were first adjusted and measured; and the calcium aspartate particles with a water activity in a range of 0.50 to 0.52 were mixed with the xylitol particles with a water activity in a range of 0.48 to 0.56 to obtain a mixture of xylitol and calcium aspartate; or maltitol particles in a weight ratio of 5%-20% to a total mass of the xylitol particles and the maltitol particles were added to the mixture of xylitol and calcium aspartate. Particle sizes of the xylitol particles were in a range of 10 mesh to 80 mesh.

The water activity was measured using a water activity meter. The water activities of the xylitol particles and the calcium aspartate particles were adjusted by drying. The methods for testing and adjusting the water activity in the Examples 2-4 are the same as those in the Example 1.

### Example 2

Water activities of xylitol particles and calcium aspartate particles were first adjusted and measured; and the calcium aspartate particles with a water activity in a range of 0.52 to 0.58 were mixed with the xylitol particles with a water activity in a range of 0.50 to 0.60 to obtain the mixture of xylitol and calcium aspartate without agglomeration; or maltitol particles in a weight ratio of 5%-20% to a total mass of the xylitol particles and the maltitol particles were added to the mixture of xylitol and calcium aspartate. Particle sizes of the xylitol particles were in a range of 10 mesh to 80 mesh.

### Example 3

100 g of xylitol particles with different water activities and particle sizes in a range of 10 mesh to 80 mesh and 8 g of calcium aspartate particles with different water activities were mixed uniformly and placed for 4 weeks. When agglomeration occurred, the agglomeration was dispersed to restore to the initial state by physical operations such as shaking, squeezing, or crushing, and then was continued to store and observe. The results were shown in Table 1.

TABLE 1
Agglomeration situation of mixtures of xylitol particles with different water
activities and calcium aspartate particles with different water activities

| Water activity of the | 0.50-0.52 | | 0.52-0.58 | |
|---|---|---|---|---|
| calcium aspartate | | | | |
| particles | | | | |
| Water activity of the | 0.48-0.56 | <0.48 or >0.56 | 0.50-0.60 | <0.50 or >0.60 |
| xylitol particles | | | | |
| Week 1 | non- | agglomeration | non- | agglomeration |
| | agglomeration | | agglomeration | |
| Week 2 | non- | agglomeration | non- | agglomeration |
| | agglomeration | | agglomeration | |
| Week 3 | non- | agglomeration | non- | agglomeration |
| | agglomeration | | agglomeration | |
| Week 4 | non- | agglomeration | non- | agglomeration |
| | agglomeration | | agglomeration | |

From the results in Table 1, it can be seen that: when the calcium aspartate calcium particles with the water activity in the range of 0.50 to 0.52 were mixed with the xylitol particles with the water activity in the range of 0.48 to 0.56, there was no agglomeration after four weeks of storage. However, when the calcium aspartate particles were mixed with xylitol particles with the water activity less than 0.48 or larger than 0.56, agglomeration occurred after one week of storage, and even if the agglomeration was dispersed back to the initial state using physical operations, agglomeration still occurred upon continued storage; when the calcium aspartate particles with the water activity in the range of 0.52 to 0.58 were mixed with the xylitol particles with the water activity in the range of 0.50 to 0.60, there was no agglomeration after storage for four weeks. However, when the calcium aspartate particles were mixed with the xylitol particles with the water activity of less than 0.50 or larger than 0.60, agglomeration occurred after one week of storage, and even after physical operations, agglomeration still occurred upon continued storage; furthermore, when 10-80 mesh of xylitol particles were screened into xylitol particles with different particle size ranges such as 10-30 mesh, 30-50 mesh, 50-60 mesh, and 60-80 mesh, the results were consistent with those of the 10-80 mesh of the xylitol particles after observing the agglomeration situation with the same method as in the Example 3.

### Example 4

100 g of a mixture of 10-80 mesh of xylitol particles with different water activities and maltitol was mixed with 8 g of calcium aspartate particles evenly for one month to observe their status. The mixture of xylitol and maltitol contains 80%-95% of xylitol and 5%-20% of maltitol. The agglomeration of the mixture was recorded and shown in Table 2. From the results in Table 2, it can be seen that: as the proportion of maltitol increased, the water activity range of xylitol particles that do not agglomerate after mixing with calcium aspartate particles expanded, indicating that xylitol particles that were prone to agglomeration may no longer agglomerate after mixing with maltitol and then mixing with calcium aspartate particles.

TABLE 2
Water activity range of xylitol particles that do not
agglomerate when mixed with calcium aspartate particles

| | The water activity of | The water activity of |
|---|---|---|
| | xylitol particles (mixed | xylitol particles (mixed |
| Proportion of | with calcium aspartate | with calcium aspartate |
| maltitol in the | particles with a water | particles with a water |
| mixture of xylitol | activity in a range of | activity in a range of |
| and maltitol | 0.50-0.52) | 0.52-0.58) |
| 5% | 0.46~0.58 | 0.48~0.62 |
| 10% | 0.43~0.60 | 0.46~0.63 |
| 15% | 0.40~0.62 | 0.43~0.65 |
| 20% | 0.36~0.66 | 0.40~0.67 |

Furthermore, when the 10-80 mesh of xylitol particles were screened into the xylitol particles with different particle size ranges such as 10-30 mesh, 30-50 mesh, 50-60 mesh, and 60-80 mesh, the results were consistent with those of the 10-80 mesh of xylitol particles after observing the agglomeration situation with the same method as in the Example 4.

The above description is only the preferred embodiments of the present disclosure and should not be used to limit the present disclosure. Any modifications, equivalent substitutions, and improvements made within the spirit and principle of the present disclosure should be included within the protection scope of the present disclosure.

What is claimed is:

1. A method for preventing agglomeration in a mixture of xylitol and calcium aspartate, comprising adjusting and measuring water activities of xylitol particles and calcium aspartate particles; and mixing calcium aspartate particles with a water activity in a range of 0.50 to 0.52 and xylitol particles with a water activity in a range of 0.48 to 0.56 to obtain a mixture of xylitol and calcium aspartate; or adding maltitol particles in a weight ratio of 5%-20% to a total mass of the xylitol particles and the maltitol particles to the mixture of the xylitol and the calcium aspartate, wherein particle sizes of the xylitol particles are in a range of 10 mesh to 80 mesh.

2. The method of claim 1, wherein when maltitol particles in a weight ratio of 5% to the total mass of the xylitol particles and the maltitol particles are added to the mixture of the xylitol and the calcium aspartate, xylitol particles with a water activity in a range of 0.46 to 0.58 and calcium aspartate particles with a water activity in a range of 0.50 to 0.52 are mixed to obtain a mixture without agglomeration.

3. The method of claim 1, wherein when maltitol particles in a weight ratio of 10% to the total mass of the xylitol particles and the maltitol particles are added to the mixture of the xylitol and the calcium aspartate, xylitol particles with a water activity in a range of 0.43 to 0.60 and calcium aspartate particles with a water activity in a range of 0.50 to 0.52 are mixed to obtain a mixture without agglomeration.

4. The method of claim 1, wherein when maltitol particles in a weight ratio of 15% to the total mass of the xylitol particles and the maltitol particles are added to the mixture of the xylitol and the calcium aspartate, xylitol particles with a water activity in a range of 0.40 to 0.62 and calcium aspartate particles with a water activity in a range of 0.50 to 0.52 are mixed to obtain a mixture without agglomeration.

5. The method of claim 1, wherein when maltitol particles in a weight ratio of 20% to the total mass of the xylitol particles and the maltitol particles are added to the mixture of the xylitol and the calcium aspartate, xylitol particles with a water activity in a range of 0.36 to 0.66 and calcium aspartate particles with a water activity in a range of 0.50 to 0.52 are mixed to obtain a mixture without agglomeration.

6. A method for preventing agglomeration in a mixture of xylitol and calcium aspartate, comprising: adjusting and measuring water activities of xylitol particles and calcium aspartate particles; and mixing calcium aspartate particles with a water activity in a range of 0.52 to 0.58 and xylitol particles with a water activity in a range of 0.50 to 0.60 to obtain the mixture of xylitol and calcium aspartate without agglomeration; or adding maltitol particles in a weight ratio of 5%-20% to a total mass of the xylitol particles and the maltitol particles to the mixture of xylitol and calcium aspartate, wherein particle sizes of the xylitol particles are in a range of 10 mesh to 80 mesh.

7. The method of claim 6, wherein when maltitol particles in a weight ratio of 5% to the total mass of the xylitol particles and the maltitol particles are added to the mixture of xylitol and calcium aspartate, xylitol particles with a water activity in a range of 0.48 to 0.62 and calcium aspartate particles with a water activity in a range of 0.52 to 0.58 are mixed to obtain a mixture without agglomeration.

8. The method of claim 6, wherein when maltitol particles in a weight ratio of 10% to the total mass of the xylitol particles and the maltitol particles are added to the mixture of xylitol and calcium aspartate, xylitol particles with a water activity in a range of 0.46 to 0.63 and calcium aspartate particles with a water activity in a range of 0.52 to 0.58 are mixed to obtain a mixture without agglomeration.

9. The method of claim 6, wherein when maltitol particles in a weight ratio of 15% to the total mass of the xylitol particles and the maltitol particles are added to the mixture of xylitol and calcium aspartate, xylitol particles with a water activity in a range of 0.43 to 0.65 and calcium aspartate particles with a water activity in a range of 0.52 to 0.58 are mixed to obtain a mixture without agglomeration.

10. The method of claim 6, wherein when maltitol particles in a weight ratio of 20% to the total mass of the xylitol particles and the maltitol particles are added to the mixture of xylitol and calcium aspartate, xylitol particles with a water activity in a range of 0.40 to 0.67 and calcium aspartate particles with a water activity in a range of 0.52 to 0.58 are mixed to obtain a mixture without agglomeration.
